(19) United States
(12) Patent Application Publication
(10) Pub. No.: US 2026/0197220 A1
(43) Pub. Date: Jul. 9, 2026

(54) PROBABILITY DISTRIBUTIONS FOR PROBABILISTIC AMPLITUDE SHAPING

(71) Applicant: QUALCOMM Incorporated, San Diego, CA (US)

(72) Inventors: Mahmoud TAHERZADEH BOROUJENI, San Diego, CA (US); Wei YANG, San Diego, CA (US); Jing JIANG, San Diego, CA (US); Juergen CEZANNE, Ocean Township, NJ (US)

(21) Appl. No.: 19/014,871

(22) Filed: Jan. 9, 2025

(51) Int. Cl. H04L 27/26; H04W 72/23

(52) U.S. Cl. CPC H04L 27/2636; H04L 27/2614; H04W 72/23

(57) ABSTRACT

Various aspects of the present disclosure generally relate to wireless communication. In some aspects, a user equipment (UE) may apply a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay. The UE may transmit a signal associated with the plurality of shaped symbols. Numerous other aspects are described.

### FIELD OF THE DISCLOSURE

Aspects of the present disclosure generally relate to wireless communication and specifically relate to techniques, apparatuses, and methods associated with probability distributions for probabilistic amplitude shaping.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a user equipment (UE) includes one or more memories; and one or more processors, the one or more processors, individually or collectively and based at least in part on information stored in the one or more memories, being configured to: apply a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and transmit a signal associated with the plurality of shaped symbols.

In some implementations, an apparatus for wireless communication at a network node includes one or more memories; and one or more processors, the one or more processors, individually or collectively and based at least in part on information stored in the one or more memories, being configured to: apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmit a signal associated with the plurality of shaped symbols.

In some implementations, a method of wireless communication performed by a UE includes applying, by the UE, a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmitting, by the UE, a signal associated with the plurality of shaped symbols.

In some implementations, a method of wireless communication performed by a network node includes applying, by the network node, a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmitting, by the network node, a signal associated with the plurality of shaped symbols.

In some implementations, a non-transitory computer-readable medium storing a set of instructions for wireless communication includes one or more instructions that, when executed by one or more processors of a UE, cause the UE to: apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmit a signal associated with the plurality of shaped symbols.

In some implementations, a non-transitory computer-readable medium storing a set of instructions for wireless communication includes one or more instructions that, when executed by one or more processors of a network node, cause the network node to: apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmit a signal associated with the plurality of shaped symbols.

In some implementations, an apparatus for wireless communication includes means for applying a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and means for transmitting a signal associated with the plurality of shaped symbols.

In some implementations, an apparatus for wireless communication includes means for applying a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and means for transmitting a signal associated with the plurality of shaped symbols.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIG. 3 is a diagram illustrating an example associated with probability distributions for probabilistic amplitude shaping, in accordance with the present disclosure.

FIG. 4 is a flowchart illustrating an example process performed, for example, by a user equipment (UE), in accordance with the present disclosure.

FIG. 5 is a flowchart illustrating an example process performed, for example, by a network node, in accordance with the present disclosure.

FIGS. 6-7 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communication system, probabilistic amplitude shaping is a technique used to improve a transmission performance by adapting a probability distribution of signal amplitudes. The probability distribution of amplitudes of transmitted symbols may be controlled, whereas in modulation schemes such as quadrature amplitude modulation (QAM), symbol amplitudes may be uniformly distributed. With probabilistic amplitude shaping, a non-uniform probability distribution may be used for amplitudes, which may allow to transmit symbols with a probability distribution that adapts to channel conditions, which may improve an overall efficiency. In probabilistic amplitude shaping, instead of using equally probable constellation points (e.g., as in standard QAM), certain symbols (amplitudes) may be transmitted more frequently than others based at least in part on a predefined probability distribution. When applying the probabilistic distribution, symbols may not be transmitted with equal probability. Probabilistic amplitude shaping may modify a constellation diagram (e.g., a mapping of data points to signal points in a complex plane) by changing a probability with which each symbol is transmitted, which is in contrast to traditional modulation schemes in which all symbols are equally likely to occur. For example, most reliable symbols (e.g., symbols that are closest to an origin in a constellation diagram) may be transmitted more frequently, while symbols located farther away (which require higher power to transmit) may be used less frequently. Common distributions used for probabilistic amplitude shaping may include a Gaussian distribution, an exponential distribution, and/or distributions based at least in part on distribution matching algorithms.

Probabilistic amplitude shaping may be an efficient mechanism for reducing an average transmit power of the modulation, while maintaining a minimum distance and/or a same required signal-to-noise ratio (SNR). While probabilistic amplitude shaping may reduce the average transmit power (e.g., by using a Gaussian-like distribution instead of uniform QAM), probabilistic amplitude shaping may increase a peak power and/or other metrics, such as a cubic metric that predicts a nonlinear contribution to an output of a power amplifier. A cubic average of power may be a favorable metric for predicting the nonlinear contribution to the output of the power amplifier and/or a signal distortion/non-linearities that are caused. Probabilistic amplitude shaping in discrete Fourier transform spread orthogonal frequency division multiplexing (DFT-s-OFDM) may need to be employed in a manner which reduces both the average transmit power, as well as the peak power and/or the cubic average of power. Otherwise, the use of probabilistic amplitude shaping may result in an increased peak power and/or an increased cubic average of power, thereby degrading an overall system performance.

Various aspects relate generally to probabilistic amplitude shaping. Some aspects more specifically relate to probability distributions for probabilistic amplitude shaping. In some examples, a UE (e.g., a transmitter) may apply a probabilistic amplitude shaping in DFT-s-OFDM to a plurality of symbols to obtain a plurality of shaped symbols. The UE may apply the probabilistic amplitude shaping to reduce one or more metrics (e.g., average power, peak power, cubic average of power, and/or PAPR) for DFT-s-OFDM waveforms. The UE may apply the probabilistic amplitude shaping by using a probability distribution that is suitable for reducing the one or more metrics. For example, the UE may apply the probabilistic amplitude shaping in DFT-s-OFDM using steeper-than-Gaussian probabilistic shaping. In this example, the probability distribution may have a steeper rate of decay as compared to a Gaussian distribution (e.g., a probability distribution having a tail that decays faster than a Gaussian distribution), which may allow for reduction of the one or more metrics. A steeper rate of decay for a distribution that is used for probabilistic shaping may reduce an average metric corresponding to higher moments of the distribution (e.g., the steeper rate of decay may reduce a probability of very large values of a norm of constellation points, which may result in a smaller average of higher moments of a constellation, e.g., E (|x|2n) for n>1). For example, a level of steepness associated with the probability distribution may be selected depending on which of the metrics are to be minimized. The probabilistic amplitude shaping may be a two-dimensional probabilistic amplitude shaping or a one-dimensional probabilistic amplitude shaping. For the two-dimensional probabilistic amplitude shaping, the probability distribution with a steeper-than-Gaussian decay may correspond to a probability distribution having a steeper decay than a Gaussian distribution in a complex plane. For the one-dimensional probabilistic amplitude shaping, the probability distribution with the steeper-than-Gaussian decay may be used together with a n/4 rotation (in radians) for every other symbol in DFT-s-OFDM.

Particular aspects of the subject matter described in this disclosure can be implemented to realize one or more of the following potential advantages. In some examples, by enabling probabilistic amplitude shaping that uses the steeper-than-Gaussian decay, the described techniques can be used by the UE and/or the network node to transmit signals associated with improved metrics. The improved metrics may be associated with reduced average power, reduced peak power, reduced cubic average of power, and/or reduced PAPR. The UE and/or the network node, by employing either the two-dimensional probabilistic amplitude shaping or the one-dimensional probabilistic amplitude shaping, may achieved reduced average power, peak power, cubic average of power, and/or PAPR (e.g., simultaneous reduction of average power, peak power, cubic average of power, and/or PAPR) in DFT-s-OFDM, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

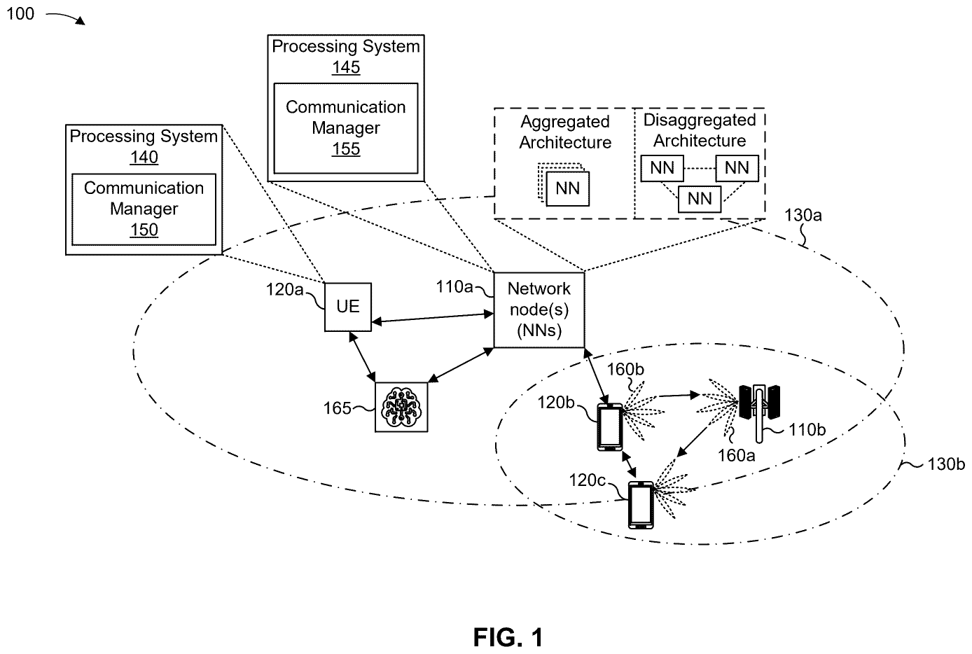

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

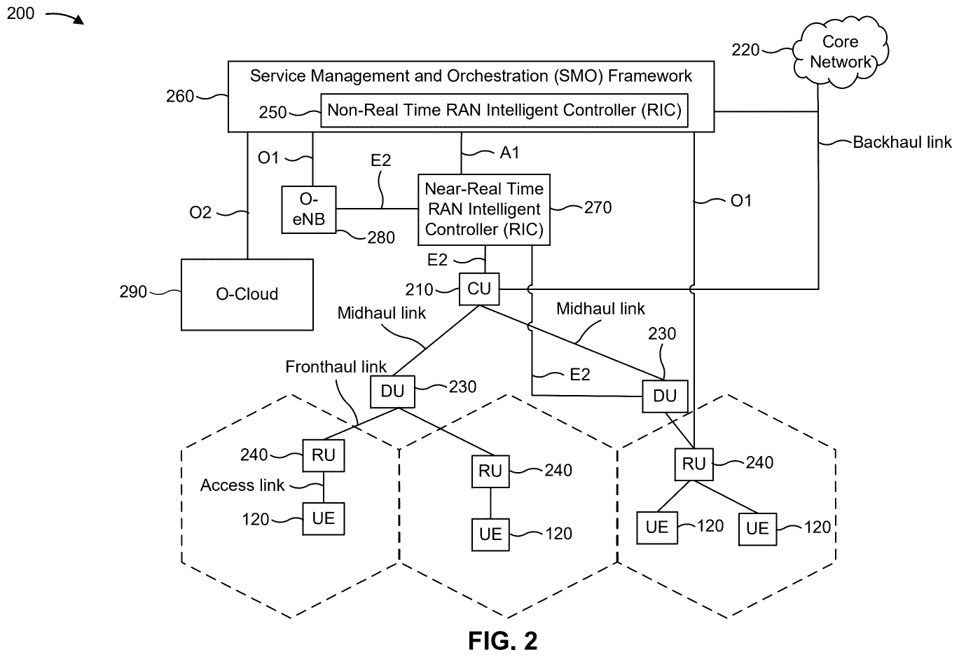

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks (RBs), and resource elements), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-s-OFDM waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of QAM, such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, a UE (e.g., the UE 120) may include a communication manager 150. As described in more detail elsewhere herein, the communication manager 150 may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmit a signal associated with the plurality of shaped symbols. Additionally, or alternatively, the communication manager 150 may perform one or more other operations described herein.

In some aspects, a network node (e.g., the network node 110) may include a communication manager 155. As described in more detail elsewhere herein, the communication manager 155 may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and transmit a signal associated with the plurality of shaped symbols. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

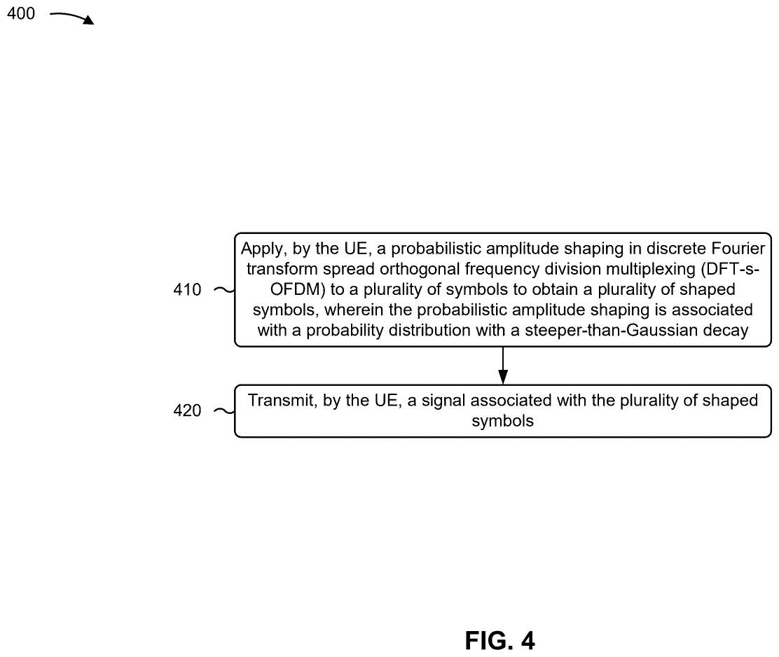

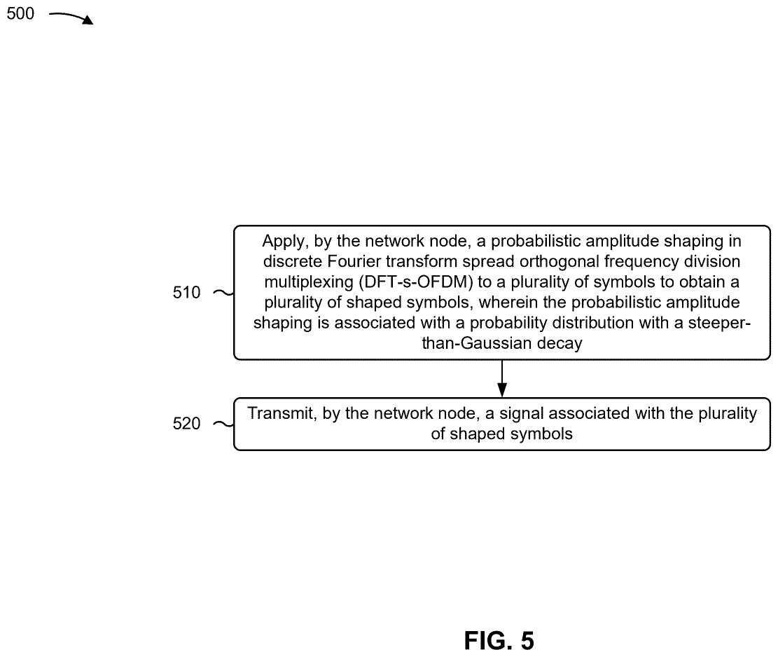

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with probability distributions for probabilistic amplitude shaping, as described in more detail elsewhere herein. For example, the processing system 145 of the network node 110, the processing system 140 of the UE 120, the CU 210, the DU 230, or the RU 240 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

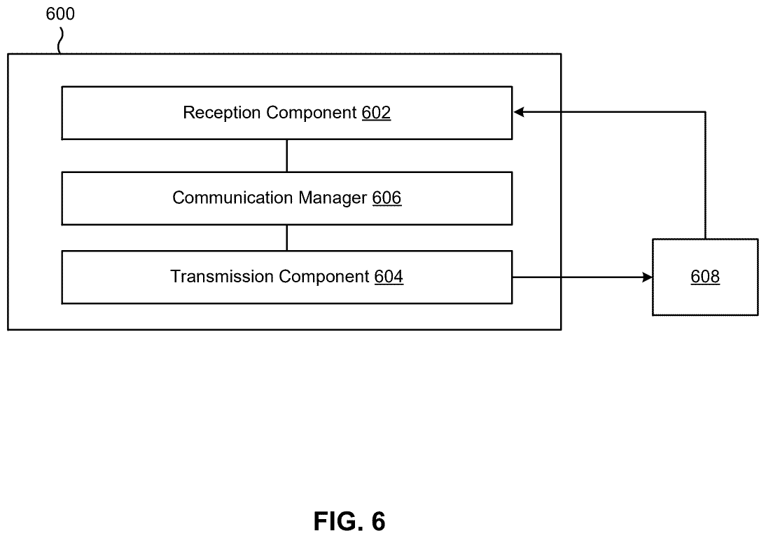

In some aspects, a UE (e.g., the UE 120) includes means for applying, by the UE, a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and/or means for transmitting, by the UE, a signal associated with the plurality of shaped symbols. The means for the UE to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), and/or a transmission component (for example, transmission component 604 depicted and described in connection with FIG. 6), among other examples.

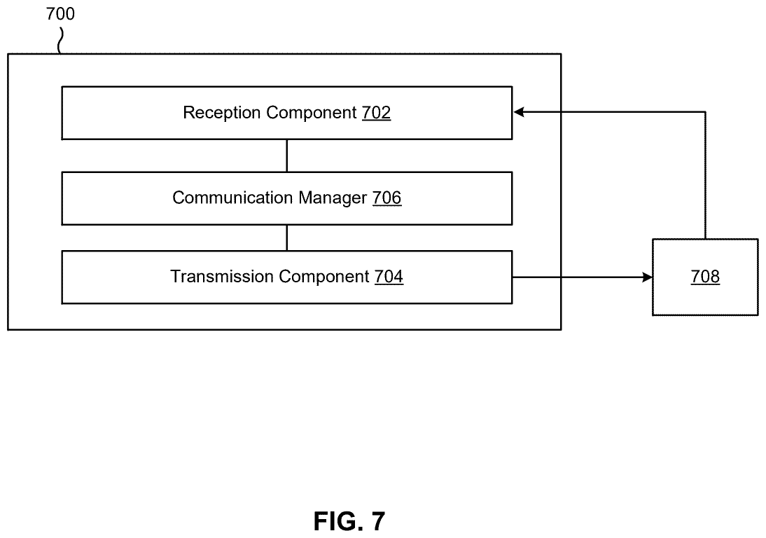

In some aspects, a network node (e.g., the network node 110) includes means for applying, by the network node, a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay; and/or means for transmitting, by the network node, a signal associated with the plurality of shaped symbols. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

As indicated above, FIG. 2 is provided as an example. Other examples may differ from what is described with regard to FIG. 2.

In a wireless communication system, OFDM is a modulation technique in which data may be split into multiple parallel subcarriers, each transmitting a portion of the data in a frequency domain. DFT-s-OFDM is a modulation technique in which an input data stream is first passed through a DFT to spread data across a larger number of subcarriers. After applying the DFT, a signal may be mapped to the frequency domain. In other words, a data sequence may first be transformed using the DFT, which may spread symbols over multiple subcarriers. The subcarriers may be transmitted in parallel, each corresponding to a point in the frequency domain. OFDM may suffer from high peak-to-average power ratio (PAPR). DFT-s-OFDM may help to mitigate the high PAPR by incorporating the DFT to spread the data over multiple subcarriers. CP-OFDM is a variant of OFDM, in which a cyclic prefix is added to each OFDM symbol to mitigate effects of multipath propagation.

DFT-s-OFDM may be desirable for PAPR-limited applications due to DFT-s-OFDM having less PAPR than CP-OFDM. However, even for DFT-s-OFDM, moderate PAPR may be encountered due to an unequal amplitude of different points of a constellation/modulation (e.g., 16 QAM or other larger QAMs). Further, a contribution from sidelobes of neighboring symbols (e.g., at middle points between sampling points) may add to the PAPR. DFT-s-OFDM may be used for uplink transmissions as well as for downlink transmissions.

Probabilistic amplitude shaping is a technique used to improve a transmission performance by adapting a probability distribution of signal amplitudes. The probability distribution of amplitudes of transmitted symbols may be controlled, whereas in modulation schemes such as QAM, symbol amplitudes may be uniformly distributed. With probabilistic amplitude shaping, a non-uniform probability distribution may be used for amplitudes, which may allow to transmit symbols with a probability distribution that adapts to channel conditions or SNR, which may improve an overall efficiency. In probabilistic amplitude shaping, instead of using equally probable constellation points (e.g., as in standard QAM), certain symbols (amplitudes) may be transmitted more frequently than others based at least in part on a predefined probability distribution. When applying the probabilistic distribution, symbols may not be transmitted with equal probability. Probabilistic amplitude shaping may modify a constellation diagram (e.g., a mapping of data points to signal points in a complex plane) by changing a probability with which each symbol is transmitted, which is in contrast to traditional modulation schemes in which all symbols are equally likely to occur. For example, most reliable symbols (e.g., symbols that are closest to an origin in a constellation diagram) may be transmitted more frequently, while symbols located farther away (which require higher power to transmit) may be used less frequently. Common distributions used for probabilistic amplitude shaping may include a Gaussian distribution, an exponential distribution, and/or distributions based at least in part on distribution matching algorithms. Whether probabilistic amplitude shaping is used or not, and if so, a type of probability distribution that is used, may be commonly known between a transmitter (e.g., UE or network node) and a receiver (e.g., UE or network node).

Probabilistic amplitude shaping may be an efficient mechanism for reducing an average transmit power of the modulation, while maintaining a minimum distance and/or a same required SNR. While probabilistic amplitude shaping may reduce the average transmit power (e.g., by using a Gaussian-like distribution instead of uniform QAM), primarily with CP-OFDM, probabilistic amplitude shaping may increase a peak power and/or other metrics, such as a cubic metric that predicts a nonlinear contribution to an output of a power amplifier. A cubic average of power may be a favorable metric for predicting the nonlinear contribution to the output of the power amplifier and/or a signal distortion/non-linearities that are caused. Probabilistic amplitude shaping in DFT-s-OFDM may need to be employed in a manner which reduces both the average transmit power, as well as the peak power and/or the cubic average of power. Otherwise, the use of probabilistic amplitude shaping may result in an increased peak power and/or an increased cubic average of power, thereby degrading an overall system performance.

In various aspects of techniques and apparatuses described herein, a UE (e.g., a transmitter) may apply a probabilistic amplitude shaping in DFT-s-OFDM to a plurality of symbols to obtain a plurality of shaped symbols. The UE may apply the probabilistic amplitude shaping to reduce one or more metrics (e.g., average power, peak power, cubic average of power, and/or PAPR) for DFT-s-OFDM waveforms. The UE may apply the probabilistic amplitude shaping by using a probability distribution that is suitable for reducing the one or more metrics. For example, the UE may apply the probabilistic amplitude shaping in DFT-s-OFDM using steeper-than-Gaussian probabilistic shaping. In this example, the probability distribution may have a steeper rate of decay as compared to a Gaussian distribution (e.g., a probability distribution having a tail that decays faster than a Gaussian distribution), which may allow for reduction of the one or more metrics. The probabilistic amplitude shaping may be a two-dimensional probabilistic amplitude shaping or a one-dimensional probabilistic amplitude shaping. For the two-dimensional probabilistic amplitude shaping, the probability distribution with a steeper-than-Gaussian decay may correspond to a probability distribution having a steeper decay than a Gaussian distribution in a complex plane. For the one-dimensional probabilistic amplitude shaping, the probability distribution with the steeper-than-Gaussian delay may be used together with a nt/4 rotation (in radians) for every other symbol in DFT-s-OFDM.

In some examples, by enabling probabilistic amplitude shaping that uses the steeper-than-Gaussian decay, the UE and/or the network node (e.g., a transmitter) may be able to transmit signals associated with improved metrics. The improved metrics may be associated with reduced average power, reduced peak power, reduced cubic average of power, and/or reduced PAPR. The UE and/or the network node, by employing either the two-dimensional probabilistic amplitude shaping or the one-dimensional probabilistic amplitude shaping with the steeper-than-Gaussian decay, may achieved reduced average power, peak power, cubic average of power, and/or PAPR (e.g., simultaneous reduction of average power, peak power, cubic average of power, and/or PAPR) in DFT-s-OFDM, thereby improving an overall system performance.

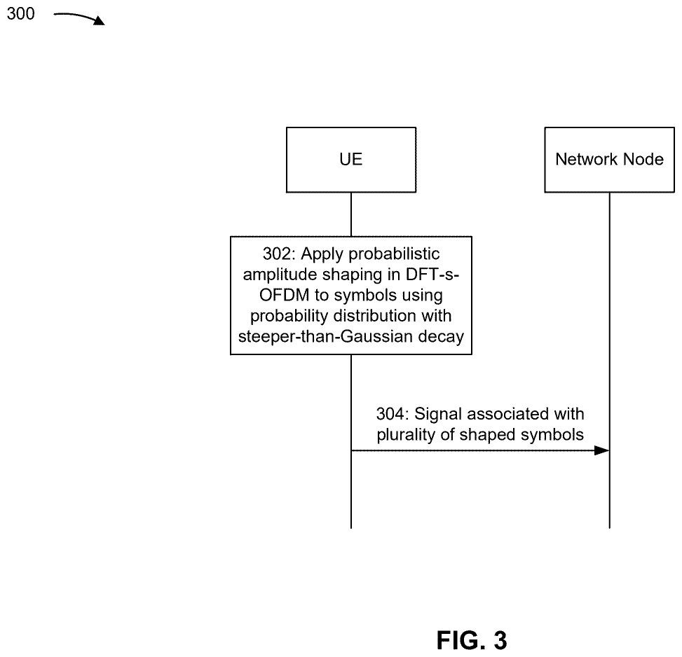

FIG. 3 is a diagram illustrating an example 300 associated with probability distributions for probabilistic amplitude shaping, in accordance with the present disclosure. As shown in FIG. 3, example 300 includes communication between a UE (e.g., UE 120) and a network node (e.g., network node 110). In some aspects, the UE and the network node may be included in a wireless network, such as wireless network 100.

As shown by reference number 302, the UE may apply a probabilistic amplitude shaping in DFT-s-OFDM to a plurality of symbols to obtain a plurality of shaped symbols. The plurality of symbols may be associated with a symbol set. The plurality of symbols may be associated with a specific, non-uniform probability distribution. Rather than a fixed constellation (e.g., 16-QAM or 64-QAM), the plurality of symbols may be based at least in part on a probabilistic approach, where each symbol may be mapped to a value based at least in part on its assigned probability. In some aspects, the probabilistic amplitude shaping may be associated with a probability distribution with a steeper-than-Gaussian decay. A Gaussian distribution (or normal distribution) may be associated with a bell-shaped curve. The Gaussian distribution may be a probability distribution that is symmetric about a mean, such that data near the mean are more frequent in occurrence than data far from the mean. The probability distribution with the steeper-than-Gaussian decay may refer to a rate of decay that is different than a rate of decay associated with the Gaussian distribution. The rate of decay may refer to how quickly a probability density function decreases when moving away from the mean. The rate of decay may be based at least in part on a standard deviation. For example, a smaller standard deviation may indicate a faster decay rate, mean that the curve drops off more rapidly from a peak, while a larger standard deviation results in a slower decay and a wider, flatter distribution.

In some aspects, the probabilistic amplitude shaping may be a two-dimensional probabilistic amplitude shaping. The probability distribution with the steeper-than-Gaussian decay may correspond to a probability distribution having a steeper decay than a Gaussian distribution in a complex plane. The probability distribution may decay faster than e-cA2, where A is an amplitude of a complex-valued symbol of a modulation and c is a constant. The probability distribution and a rate of decay for a probability density associated with the probability distribution may be based at least in part on a metric to be minimized or reduced. The metric may be an average power, a peak power, a cubic average of power, and/or a PAPR. In other words, depending on a desired metric, the probability distribution and the rate of decay for the probability density may be selected. Average power, peak power, and cubic average of power may be associated with different probability distributions and different rate of decays for the probability densities. The cubic average of power may refer to a calculation of an average power value where each data point is cubed before averaging, which may assign more weight to larger power values in the probability distribution. In some aspects, the UE may apply the probabilistic amplitude shaping to a constellation or a modulation with b bits by shaping b−2 bits for each quadrant in a complex plane and using 2 unshaped bits for a quadrant selection, where b is a positive integer. The 2 unshaped bits may be associated with a mapping of one or more parity bits of a forward error correction.

In some aspects, for a fixed average power, a distribution that maximizes a differential entropy may have Gaussian-like distribution (e.g., a probability density may be proportional to e^{-cA}^{²}, where A is an amplitude of constellation/modulation points and c is a constant). For a fixed differential entropy (e.g., a fixed supported spectral efficiency), an average power may be minimized when the modulation has the Gaussian-like distribution. Similarly, for the fixed differential entropy, a cubic average of power may be minimized when a modulation has a distribution with a density proportional to e^{-cA}^{⁶}. In some aspects, a peak power of a modulation in DFT-s-OFDM may not only be dependent on a peak of an amplitude at one or more sampling points, but also at other points of a waveform. In most cases, a bottleneck for the peak may be at one or more midpoints (e.g., at point

$$T ( k + \frac{1}{2} )$$

for integer values of k). At that point, the amplitude of a signal, based at least in part on a sinc formula (sampling formula) for each of the symbols S(x), may be in accordance with:

$$\vert s ( T ( k + \frac{1}{2} ) ) \vert = \vert … + S ( k - 2 ) \times \frac{2}{5 π} - S ( k - 1 ) \times \frac{2}{3 π} + S ( k ) \times \frac{2}{π} + S ( k + 1 ) \times \frac{2}{π} - S ( k + 2 ) \times \frac{2}{3 π} + S ( k + 3 ) \times \frac{2}{5 π} - … \vert .$$

While optimizing the cubic average of power using probabilistic amplitude shaping may not be directly linked to PAPR reduction, probabilistic amplitude shaping may improve the distribution (and a typical peak) of the signal at midpoints of the signal.

In some aspects, a low-PAPR transmission in DFT-s-OFDM may use probabilistic amplitude shaping with a steeper-than-Gaussian decay in a complex plane. The probabilistic amplitude shaping with the steeper-than-Gaussian decay may utilize a distribution having a tail that decays faster than a Gaussian-like distribution. For a simultaneous reduction of peak power and average power in DFT-s-OFDM, probabilistic amplitude shaping may be used with the steeper-than-Gaussian decay in the complex plane. With the steeper-than-Gaussian decay in the complex plane, a probability distribution of a modulation may decay faster than e^{-cA}^{²}, where A is an amplitude of a complex-valued symbol of a modulation and c is a constant. A selected distribution (and a rate of decay for a probability density) may depend on a metric that is to be minimized (e.g., cubic metric, PAPR, or other metrics). In one example, the probabilistic amplitude shaping for the modulation may use a probability distribution with a density proportional to e^{-cA}^{⁶}. The probabilistic amplitude shaping may be a two-dimensional probabilistic amplitude shaping. The two-dimensional probabilistic amplitude shaping, which may be for a constellation/modulation with a b bits labeling, may be achieved by shaping b−2 bits (for each quadrant of the complex plane), and by using two unshaped bits for a selection of the quadrant in the complex plane. When using forward error correction (FEC), unshaped bits may be used for a mapping of parity bits of the FEC (while shaping is only done for information bits).

In some aspects, evaluated metrics may be obtained for constellations with a spectral efficiency of 4 bits per second per hertz (bits/s/Hz). With 16-QAM, an improvement/reduction in a second moment (average energy) may serve as a baseline, and an improvement/reduction in a sixth moment or a cubic average of power (related to the cubic metric) at sampling points may serve as a baseline. The average energy may be associated with an average transmit power. For probabilistic amplitude shaping using a Boltzmann distribution (e.g., a Gaussian-like distribution) on 64-QAM with an entropy of 4 bits, the improvement/reduction in the second moment (average energy) may be approximately-1.25 decibels (dB), and the improvement/reduction in the sixth moment or the cubic average of power (related to the cubic metric) at sampling points may be approximately +0.35 dB (corresponding to an approximately +1.6 dB worse cubic metric). For probabilistic amplitude shaping using the steeper-than-Gaussian decay in the complex plane on 64-QAM with an entropy of 4 bits (e.g., two-dimensional probabilistic amplitude shaping using the stepper than Gaussian decay in the complex plane), the improvement/reduction in the second moment (average energy) may be approximately-0.77 dB, and the improvement/reduction in the sixth moment or the cubic average of power (related to the cubic metric) at sampling points may be approximately-0.46 dB (corresponding to an approximately +0.31 dB worse cubic metric, but overall, a better sixth moment or cubic average of power).

In some aspects, an evaluated PAPR may be obtained for a constellation with a spectral efficiency of 4 bits/s/Hz. A PAPR (in dB) of a DFT-s-OFDM transmission on a number of RBs (e.g., 8 RBs) in relation to a complementary cumulative distribution function (CCDF) may be obtained for 16-QAM versus the probabilistic amplitude shaping using the steeper-than-Gaussian decay in the complex plane. The probabilistic amplitude shaping using the steeper-than-Gaussian decay in the complex plane may be associated with an approximately 0.35 dB worse PAPR, as compared to 16-QAM, but approximately 0.4 dB of less peak power (which translates to an approximately 0.77 dB improvement in average power).

In some aspects, the probabilistic amplitude shaping may be a one-dimensional probabilistic amplitude shaping. The probability distribution with the steeper-than-Gaussian decay may correspond to a probability distribution having a steeper decay than a Gaussian distribution for a QAM. The probabilistic amplitude shaping may be applied together with a π/4 rotation for every other symbol in DFT-s-OFDM. Alternatively, the probabilistic amplitude shaping may be applied together with a rotation for a

$$k \times \frac{π}{4}$$

rotation for a k-th symbol in DFT-s-OFDM, where k is a positive integer. In some aspects, the UE may apply the probabilistic amplitude shaping to a constellation or a modulation with b bits by shaping b−1 bits in a dimension and using one unshaped bit for a sign of a symbol in the dimension, where b is a positive integer. The one unshaped bit may be associated with a mapping of one or more parity bits of a forward error correction.

In some aspects, the probabilistic amplitude shaping may be in one dimension or in two dimensions. With one-dimensional probabilistic amplitude shaping, a signal amplitude may be shaped probabilistically along a single axis. With two-dimensional probabilistic amplitude shaping, both an in-phase (I) component and a quadrature (Q) component of the signal may be shaped, which means that both real and imaginary parts of a complex signal (in an I/Q plane) may be selected probabilistically and not just the amplitude. Two-dimensional probabilistic amplitude shaping may be used in modulation schemes where the signal constellation has two dimensions, where such systems take advantage of both amplitude and phase dimensions to encode information. In two-dimensional probabilistic amplitude shaping, amplitude shaping may be applied to both the I and Q components. The I and Q components may correspond to two orthogonal signal components, such as real and imaginary components. The I and Q components of a given symbol may not be uniformly distributed across the constellation grid, but rather their values may be drawn from specific probability distributions. The constellation grid may be considered as a shaped probability distribution across an I/Q plane, where amplitude values (in both I and Q directions) are chosen with certain probabilities and a phase of each symbol may be determined by a combination of the I and Q components.

In some aspects, one-dimensional probabilistic amplitude shaping may be easier to implement than two-dimensional probabilistic amplitude shaping because the one-dimensional probabilistic amplitude shaping may use a smaller set of distinct probabilities for generating constellation points. One-dimensional probabilistic amplitude shaping may result in less rate loss than two-dimensional probabilistic amplitude shaping when a code block is relatively small. For Gaussian-like distributions, one-dimensional probabilistic amplitude and two-dimensional probabilistic amplitude shaping may result in the same distribution because two independent and identically distributed Gaussian-like distributions may result in a circular symmetry for a two-variable Gaussian distribution. However, for other distributions (e.g., distributions that decays in accordance with e^{-c|x|}^{⁶} in one dimension, a joint distribution of two independent and identically distributions may not have a circular symmetry). While increasing a speak power and cubic average of power at one or more sampling points, such asymmetry may be used to reduce a PAPR at one or more midpoints by using different rotations for consecutive symbols to reduce an amplitude of a midpoint to avoid an alignment, in accordance with:

$$\vert s ( T ( k + \frac{1}{2} ) ) \vert = \vert … + S ( k - 2 ) \times \frac{2}{5 π} - S ( k - 1 ) \times \frac{2}{3 π} + S ( k ) \times \frac{2}{π} + S ( k + 1 ) \times \frac{2}{π} - S ( k + 2 ) \times \frac{2}{3 π} + S ( k + 3 ) \times \frac{2}{5 π} - … \vert .$$

In some aspects, one-dimensional probabilistic amplitude shaping with a steeper-than-Gaussian delay for QAM modulation may be used together with a π/4 rotation for every other symbol in DFT-s-OFDM. With Gaussian shaping, two independent one-dimensional shaping using a steeper-than-Gaussian distribution may not be circularly symmetric. Rotating every other symbol may reduce a norm of a summation of two adjacent symbols (which is an important factor in a peak amplitude of a signal at a midpoint between a center of two pulses associated with two adjacent symbols). The one-dimensional probabilistic amplitude shaping with the steeper-than-Gaussian delay for QAM modulation, together with the π/4 rotation (in radians) for every other symbol, may be used for reducing the PAPR, peak power, and/or cubic metric in DFT-s-OFDM. In some aspects, instead of the π/4 rotation, a kth symbol S(k) may be rotated by

$$k \times \frac{π}{4}$$

radians. A selected one-dimensional distribution (and a rate of decay for a probability density) may depend on the metric that is to be minimized (e.g., cubic metric, PAPR, or other metrics). In one example, the one-dimensional probabilistic amplitude shaping for a modulation may use a distribution with a density proportional to e-cxl′, where x is a projection of a complex-valued symbol in one dimension (e.g., in an I axis or a Q axis), and c is a constant. A one-dimensional probabilistic amplitude shaping for a constellation/modulation with a b bits labeling may be achieved by shaping b−1 bits in each dimension, and by using one unshaped bit for a sign of a symbol in that dimension. When using FEC, unshaped bits may be used for a mapping of parity bits of the FEC (while shaping is only done for information bits).

In some aspects, evaluated metrics may be obtained for constellations with a spectral efficiency of 4 bits/s/Hz. With 16-QAM, an improvement/reduction in a second moment (average energy) may serve as a baseline, and an improvement/reduction in a sixth moment or a cubic average of power (related to the cubic metric) at sampling points may serve as a baseline. For one-dimensional probabilistic amplitude shaping using the steeper-than-Gaussian decay for QAM modulation, together with the Tt/4 rotation for every other symbol in DFT-s-OFDM, on 64-QAM with an entropy of 4 bits, the improvement/reduction in the second moment (average energy) may be approximately-0.47 dB, and the improvement/reduction in the sixth moment or cubic average of power (related to the cubic metric) at sampling points may be approximately-0.25 dB (corresponding to an approximately +0.21 dB worse cubic metric, but overall, a better sixth moment or cubic average of power).

In some aspects, an evaluated PAPR may be obtained for a constellation with a spectral efficiency of 4 bits/s/Hz, where statistics of the evaluated PAPR may be based at least in part on a peak of a whole waveform. A PAPR (in dB) of a DFT-s-OFDM transmission on a number of RBs (e.g., 8 RBs) in relation to a CCDF may be obtained for 16-QAM versus one-dimensional probabilistic amplitude shaping with a steeper-than-Gaussian decay together with a n/4 rotation of every other symbol. The one-dimensional probabilistic amplitude shaping may be associated with an approximately 0.1-0.15 dB worse PAPR, as compared to 16-QAM, but approximately 0.35 dB of less peak power (which translates to an approximately 0.47 dB improvement in average power).

In some aspects, an evaluated PAPR may be obtained for a constellation with a spectral efficiency of 4 bits/s/Hz, where statistics of the evaluated PAPR may be based at least in part on a peak per symbol duration. A PAPR (in dB) of a DFT-s-OFDM transmission on a number of RBs (e.g., 8 RBs) in relation to a CCDF may be obtained for 16-QAM versus one-dimensional probabilistic amplitude shaping with a steeper-than-Gaussian decay together with a n/4 rotation of every other symbol. The PAPR may be based at least in part on the peak per symbol duration, instead of a peak of a whole waveform. The one-dimensional probabilistic amplitude shaping may be associated with an approximately 0-0.25 dB worse PAPR, as compared to 16-QAM, but approximately 0.2-0.45 dB of less peak power (which translates to an approximately 0.47 dB improvement in average power).

In some aspects, a change in power backoff assuming a hard clipping and a resulting signal distortion may be defined. For 16-QAM in DFT-s-OFDM, a hard clipping at approximately 4.5 dB may be applied. For 16-QAM in DFT-s-OFDM, the hard clipping at 4.5 dB may result in an approximately 31 dB distortion noise. For one-dimensional probabilistic amplitude shaping with a steeper-than-Gaussian decay together with a n/4 rotation of every other symbol, a threshold of approximately 4.5 dB of hard clipping may result in the same amount of distortion noise. The one-dimensional probabilistic amplitude shaping may be associated with an approximately 0.15 dB more power backoff needed (assuming hard clipping), as compared to 16-QAM, but an approximately 0.3 dB improvement in a required SNR (which translates to an approximately 0.47 dB improvement in average power).

As shown by reference number 304, the UE may transmit, to the network node or to a second UE, a signal associated with the plurality of shaped symbols. For example, when the UE is a first UE, the UE may transmit a sidelink signal to the second UE. In this example, the UE may be a transmitter and the second UE may be a receiver. As another example, the UE may transmit an uplink signal to the network node. In this example, the UE may be a transmitter and the network node may be a receiver. In some aspects, the network node or the second UE may decode the signal associated with the plurality of shaped symbols. The network node or the second UE may store information associated with the probabilistic amplitude shaping, which may allow the network node or the second UE to receive and decode the signal associated with the plurality of shaped symbols.

In some aspects, the network node may apply a probabilistic amplitude shaping in DFT-s-OFDM to a plurality of symbols to obtain a plurality of shaped symbols. The probabilistic amplitude shaping may be associated with a probability distribution with a steeper-than-Gaussian decay. The network node may transmit, to the UE, a signal associated with the plurality of shaped symbols. In this example, the network node may be a transmitter and the UE may be a receiver. The network node may apply the probabilistic amplitude shaping, similar to the UE as described herein.

As indicated above, FIG. 3 is provided as an example. Other examples may differ from what is described with regard to FIG. 3.

FIG. 4 is a diagram illustrating an example process 400 performed, for example, at a UE or an apparatus of a UE, in accordance with the present disclosure. Example process 400 is an example where the apparatus or the UE (e.g., UE 120) performs operations associated with probability distributions for probabilistic amplitude shaping.

As shown in FIG. 4, in some aspects, process 400 may include applying a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay (block 410). For example, the UE (e.g., using communication manager 606, depicted in FIG. 6) may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay, as described above.

As further shown in FIG. 4, in some aspects, process 400 may include transmitting a signal associated with the plurality of shaped symbols (block 420). For example, the UE (e.g., using transmission component 604 and/or communication manager 606, depicted in FIG. 6) may transmit a signal associated with the plurality of shaped symbols, as described above.

Process 400 may include additional aspects, such as any single aspect or any combination of aspects described below and/or in connection with one or more other processes described elsewhere herein.

In a first aspect, the probability distribution with the steeper-than-Gaussian decay corresponds to a probability distribution having a steeper decay than a Gaussian distribution in a complex plane.

In a second aspect, alone or in combination with the first aspect, the probability distribution decays faster than e-CA′, where A is an amplitude of a complex-valued symbol of a modulation and c is a constant.

In a third aspect, alone or in combination with one or more of the first and second aspects, the probability distribution and a rate of decay for a probability density associated with the probability distribution is based at least in part on a metric to be minimized.

In a fourth aspect, alone or in combination with one or more of the first through third aspects, the metric is one or more of an average power, a peak power, a cubic average of power, or a PAPR.

In a fifth aspect, alone or in combination with one or more of the first through fourth aspects, the probabilistic amplitude shaping is a two-dimensional probabilistic amplitude shaping.

In a sixth aspect, alone or in combination with one or more of the first through fifth aspects, process 400 includes applying the probabilistic amplitude shaping to a constellation or a modulation with b bits by shaping b−2 bits for each quadrant in a complex plane and using 2 unshaped bits for a quadrant selection, wherein b is a positive integer, and the 2 unshaped bits are associated with a mapping of one or more parity bits of a forward error correction.

In a seventh aspect, alone or in combination with one or more of the first through sixth aspects, the probabilistic amplitude shaping is a one-dimensional probabilistic amplitude shaping.

In an eighth aspect, alone or in combination with one or more of the first through seventh aspects, process 400 includes applying the probabilistic amplitude shaping together with a π/4 rotation for every other symbol in DFT-s-OFDM.

In a ninth aspect, alone or in combination with one or more of the first through eighth aspects, the probability distribution with the steeper-than-Gaussian decay corresponds to a probability distribution having a steeper decay than a Gaussian distribution for a quadrature amplitude modulation.

In a tenth aspect, alone or in combination with one or more of the first through ninth aspects, process 400 includes applying the probabilistic amplitude shaping together with a

$$k \times \frac{π}{4}$$

rotation for a k-th symbol in DFT-s-OFDM, where k is a positive integer.

In an eleventh aspect, alone or in combination with one or more of the first through tenth aspects, process 400 includes applying the probabilistic amplitude shaping to a constellation or a modulation with b bits by shaping b−1 bits in a dimension and using one unshaped bit for a sign of a symbol in the dimension, where b is a positive integer, and the one unshaped bit is associated with a mapping of one or more parity bits of a forward error correction.

In a twelfth aspect, alone or in combination with one or more of the first through eleventh aspects, the UE is a first UE, and process 400 includes transmitting a sidelink signal to a second UE or transmitting an uplink signal to a network node.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node, in accordance with the present disclosure. Example process 500 is an example where the apparatus or the network node (e.g., network node 110) performs operations associated with probability distributions for probabilistic amplitude shaping.

As shown in FIG. 5, in some aspects, process 500 may include applying a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay (block 510). For example, the network node (e.g., using communication manager 706, depicted in FIG. 7) may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay, as described above.

As further shown in FIG. 5, in some aspects, process 500 may include transmitting a signal associated with the plurality of shaped symbols (block 520). For example, the network node (e.g., using transmission component 704 and/or communication manager 706, depicted in FIG. 7) may transmit a signal associated with the plurality of shaped symbols, as described above.

Process 500 may include additional aspects, such as any single aspect or any combination of aspects described below and/or in connection with one or more other processes described elsewhere herein.

In a first aspect, the probability distribution with the steeper-than-Gaussian decay corresponds to a probability distribution having a steeper decay than a Gaussian distribution in a complex plane.

In a second aspect, alone or in combination with the first aspect, the probability distribution decays faster than e^{-cA}^{²}, where A is an amplitude of a complex-valued symbol of a modulation and c is a constant.

In a third aspect, alone or in combination with one or more of the first and second aspects, the probability distribution and a rate of decay for a probability density associated with the probability distribution is based at least in part on a metric to be minimized.

In a fourth aspect, alone or in combination with one or more of the first through third aspects, the metric is one or more of an average power, a peak power, a cubic average of power, or a PAPR.

In a fifth aspect, alone or in combination with one or more of the first through fourth aspects, the probabilistic amplitude shaping is a two-dimensional probabilistic amplitude shaping.

In a sixth aspect, alone or in combination with one or more of the first through fifth aspects, process 500 includes applying the probabilistic amplitude shaping to a constellation or a modulation with b bits by shaping b−2 bits for each quadrant in a complex plane and using 2 unshaped bits for a quadrant selection, where b is a positive integer, and the 2 unshaped bits are associated with a mapping of one or more parity bits of a forward error correction.

In a seventh aspect, alone or in combination with one or more of the first through sixth aspects, the probabilistic amplitude shaping is a one-dimensional probabilistic amplitude shaping.

In an eighth aspect, alone or in combination with one or more of the first through seventh aspects, process 500 includes applying the probabilistic amplitude shaping together with a π/4 rotation for every other symbol in DFT-s-OFDM.

In a ninth aspect, alone or in combination with one or more of the first through eighth aspects, the probability distribution with the steeper-than-Gaussian decay corresponds to a probability distribution having a steeper decay than a Gaussian distribution for a quadrature amplitude modulation.

In a tenth aspect, alone or in combination with one or more of the first through ninth aspects, process 500 includes applying the probabilistic amplitude shaping together with a

$$k \times \frac{π}{4}$$

rotation for a k-th symbol in DFT-s-OFDM, where k is a positive integer.

In an eleventh aspect, alone or in combination with one or more of the first through tenth aspects, process 500 includes applying the probabilistic amplitude shaping to a constellation or a modulation with b bits by shaping b−1 bits in a dimension and using one unshaped bit for a sign of a symbol in the dimension, where b is a positive integer, and the one unshaped bit is associated with a mapping of one or more parity bits of a forward error correction.

In a twelfth aspect, alone or in combination with one or more of the first through eleventh aspects, process 500 includes transmitting a downlink signal to a UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602, a transmission component 604, and/or a communication manager 606, which may be in communication with one another (for example, via one or more buses and/or one or more other components). In some aspects, the communication manager 606 is the communication manager 150 described in connection with FIG. 1. As shown, the apparatus 600 may communicate with another apparatus 608, such as a UE or a network node (such as a CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 and/or the transmission component 604. For example, the communication manager 606 may receive information associated with configuring reception of communications by the reception component 602 and/or transmission of communications by the transmission component 604. Additionally, or alternatively, the communication manager 606 may generate and/or provide control information to the reception component 602 and/or the transmission component 604 to control reception and/or transmission of communications.

The communication manager 606 may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay. The transmission component 604 may transmit a signal associated with the plurality of shaped symbols.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a network node, or a network node may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 155 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 and/or the transmission component 704 may include or may be included in a network interface. The network interface may be configured to obtain and/or output signals for the apparatus 700 via one or more communications links, such as a backhaul link, a midhaul link, and/or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The communication manager 706 may apply a probabilistic amplitude shaping in DFT-s-OFDM to a plurality of symbols to obtain a plurality of shaped symbols, wherein the probabilistic amplitude shaping is associated with a probability distribution with a steeper-than-Gaussian decay. The transmission component 704 may transmit a signal associated with the plurality of shaped symbols.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: applying, by the UE, a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and transmitting, by the UE, a signal associated with the plurality of shaped symbols.

Aspect 2: The method of Aspect 1, wherein the probability distribution with the steeper-than-Gaussian decay corresponds to a probability distribution having a steeper decay than a Gaussian distribution in a complex plane.

Aspect 3: The method of any of Aspects 1-2, wherein the probability distribution decays faster than e^{-cA}^{²}, where A is an amplitude of a complex-valued symbol of a modulation and c is a constant.

Aspect 4: The method of any of Aspects 1-3, wherein the probability distribution and a rate of decay for a probability density associated with the probability distribution is based at least in part on a metric to be minimized.

Aspect 5: The method of Aspect 4, wherein the metric is one or more of: an average power, a peak power, a cubic average of power, or a peak-to-average power ratio (PAPR).

Aspect 6: The method of any of Aspects 1-5, wherein the probabilistic amplitude shaping is a two-dimensional probabilistic amplitude shaping.

Aspect 7: The method of any of Aspects 1-6, wherein applying the probabilistic amplitude shaping comprises applying the probabilistic amplitude shaping to a constellation or a modulation with b bits by shaping b−2 bits for each quadrant in a complex plane and using 2 unshaped bits for a quadrant selection, where b is a positive integer, and wherein the 2 unshaped bits are associated with a mapping of one or more parity bits of a forward error correction.

Aspect 8: The method of any of Aspects 1-7, wherein the probabilistic amplitude shaping is a one-dimensional probabilistic amplitude shaping.

Aspect 9: The method of any of Aspects 1-8, wherein applying the probabilistic amplitude shaping comprises applying the probabilistic amplitude shaping together with a π/4 rotation for every other symbol in DFT-s-OFDM.

Aspect 10: The method of any of Aspects 1-9, wherein the probability distribution with the steeper-than-Gaussian decay corresponds to a probability distribution having a steeper decay than a Gaussian distribution for a quadrature amplitude modulation.

Aspect 11: The method of any of Aspects 1-10, wherein applying the probabilistic amplitude shaping comprises applying the probabilistic amplitude shaping together with a

$$k \times \frac{π}{4}$$

rotation for a K-in symbol in DFT-s-OFDM, where k is a positive integer.

Aspect 12: The method of any of Aspects 1-11, wherein applying the probabilistic amplitude shaping comprises applying the probabilistic amplitude shaping to a constellation or a modulation with b bits by shaping b−1 bits in a dimension and using one unshaped bit for a sign of a symbol in the dimension, where b is a positive integer, and wherein the one unshaped bit is associated with a mapping of one or more parity bits of a forward error correction.

Aspect 13: The method of any of Aspects 1-12, wherein the UE is a first UE, and wherein transmitting the signal comprises transmitting a sidelink signal to a second UE or transmitting an uplink signal to a network node.

Aspect 14: A method of wireless communication performed by a network node, comprising: applying, by the network node, a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and transmitting, by the network node, a signal associated with the plurality of shaped symbols.

Aspect 15: The method of Aspect 14, wherein the probability distribution with the steeper-than-Gaussian decay corresponds to a probability distribution having a steeper decay than a Gaussian distribution in a complex plane.

Aspect 16: The method of any of Aspects 14-15, wherein the probability distribution decays faster than e^{-cA}^{²}, where A is an amplitude of a complex-valued symbol of a modulation and c is a constant.

Aspect 17: The method of any of Aspects 14-16, wherein the probability distribution and a rate of decay for a probability density associated with the probability distribution is based at least in part on a metric to be minimized.

Aspect 18: The method of Aspect 17, wherein the metric is one or more of: an average power, a peak power, a cubic average of power, or a peak-to-average power ratio (PAPR).

Aspect 19: The method of any of Aspects 14-18, wherein the probabilistic amplitude shaping is a two-dimensional probabilistic amplitude shaping.

Aspect 20: The method of any of Aspects 14-19, wherein applying the probabilistic amplitude shaping comprises applying the probabilistic amplitude shaping to a constellation or a modulation with b bits by shaping b−2 bits for each quadrant in a complex plane and using 2 unshaped bits for a quadrant selection, where b is a positive integer, and wherein the 2 unshaped bits are associated with a mapping of one or more parity bits of a forward error correction.

Aspect 21: The method of any of Aspects 14-20, wherein the probabilistic amplitude shaping is a one-dimensional probabilistic amplitude shaping.

Aspect 22: The method of any of Aspects 14-21, wherein applying the probabilistic amplitude shaping comprises applying the probabilistic amplitude shaping together with a π/4 rotation for every other symbol in DFT-s-OFDM.

Aspect 23: The method of any of Aspects 14-22, wherein the probability distribution with the steeper-than-Gaussian decay corresponds to a probability distribution having a steeper decay than a Gaussian distribution for a quadrature amplitude modulation.

Aspect 24: The method of any of Aspects 14-23, wherein applying the probabilistic amplitude shaping comprises applying the probabilistic amplitude shaping together with a

$$k \times \frac{π}{4}$$

rotation for a k-th symbol in DFT-s-OFDM, where k is a positive integer.

Aspect 25: The method of any of Aspects 14-24, wherein applying the probabilistic amplitude shaping comprises applying the probabilistic amplitude shaping to a constellation or a modulation with b bits by shaping b−1 bits in a dimension and using one unshaped bit for a sign of a symbol in the dimension, where b is a positive integer, and wherein the one unshaped bit is associated with a mapping of one or more parity bits of a forward error correction.

Aspect 26: The method of any of Aspects 14-25, wherein transmitting the signal comprises transmitting a downlink signal to a user equipment.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, the one or more processors, individually or collectively and based at least in part on information stored in the one or more memories, being configured to:
apply a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and
transmit a signal associated with the plurality of shaped symbols.

2. The apparatus of claim 1, wherein the probability distribution with the steeper-than-Gaussian decay corresponds to a probability distribution having a steeper decay than a Gaussian distribution in a complex plane.

3. The apparatus of claim 1, wherein the probability distribution decays faster than e^{-cA}^{²}, where A is an amplitude of a complex-valued symbol of a modulation and c is a constant.

4. The apparatus of claim 1, wherein the probability distribution and a rate of decay for a probability density associated with the probability distribution is based at least in part on a metric to be minimized.

5. The apparatus of claim 4, wherein the metric is one or more of: an average power, a peak power, a cubic average of power, or a peak-to-average power ratio (PAPR).

6. The apparatus of claim 1, wherein the probabilistic amplitude shaping is a two-dimensional probabilistic amplitude shaping.

7. The apparatus of claim 1, wherein the one or more processors, individually or collectively and based at least in part on the information stored in the one or more memories, are further configured to:
apply the probabilistic amplitude shaping to a constellation or a modulation with b bits by shaping b−2 bits for each quadrant in a complex plane and using 2 unshaped bits for a quadrant selection, where b is a positive integer, and wherein the 2 unshaped bits are associated with a mapping of one or more parity bits of a forward error correction.

8. The apparatus of claim 1, wherein the probabilistic amplitude shaping is a one-dimensional probabilistic amplitude shaping.

9. The apparatus of claim 1, wherein the one or more processors, individually or collectively and based at least in part on the information stored in the one or more memories, are further configured to:
apply the probabilistic amplitude shaping together with a π/4 rotation for every other symbol in DFT-s-OFDM.

10. The apparatus of claim 1, wherein the probability distribution with the steeper-than-Gaussian decay corresponds to a probability distribution having a steeper decay than a Gaussian distribution for a quadrature amplitude modulation.

11. The apparatus of claim 1, wherein the one or more processors, individually or collectively and based at least in part on the information stored in the one or more memories, are further configured to:
apply the probabilistic amplitude shaping together with a
$$k \times \frac{π}{4}$$
rotation for a k-th symbol in DFT-s-OFDM, where k is a positive integer.

12. The apparatus of claim 1, wherein the one or more processors, individually or collectively and based at least in part on the information stored in the one or more memories, are further configured to:
apply the probabilistic amplitude shaping to a constellation or a modulation with b bits by shaping b−1 bits in a dimension and using one unshaped bit for a sign of a symbol in the dimension, where b is a positive integer, and wherein the one unshaped bit is associated with a mapping of one or more parity bits of a forward error correction.

13. The apparatus of claim 1, wherein the UE is a first UE, and wherein the one or more processors, individually or collectively and based at least in part on the information stored in the one or more memories, are further configured to:
transmit a sidelink signal to a second UE or transmit an uplink signal to a network node.

14. An apparatus for wireless communication at a network node, comprising:
one or more memories; and
one or more processors, the one or more processors, individually or collectively and based at least in part on information stored in the one or more memories, being configured to:
apply a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and
transmit a signal associated with the plurality of shaped symbols.

15. The apparatus of claim 14, wherein the probability distribution with the steeper-than-Gaussian decay corresponds to a probability distribution having a steeper decay than a Gaussian distribution in a complex plane.

16. The apparatus of claim 14, wherein the probability distribution and a rate of decay for a probability density associated with the probability distribution is based at least in part on a metric to be minimized.

17. The apparatus of claim 14, wherein the one or more processors, individually or collectively and based at least in part on the information stored in the one or more memories, are further configured to:
apply the probabilistic amplitude shaping together with a π/4 rotation for every other symbol in DFT-s-OFDM.

18. The apparatus of claim 14, wherein the probability distribution with the steeper-than-Gaussian decay corresponds to a probability distribution having a steeper decay than a Gaussian distribution for a quadrature amplitude modulation.

19. The apparatus of claim 14, wherein the one or more processors, individually or collectively and based at least in part on the information stored in the one or more memories, are further configured to:
transmit a downlink signal to a user equipment.

20. A method of wireless communication performed by a user equipment (UE), comprising:
applying, by the UE, a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and
transmitting, by the UE, a signal associated with the plurality of shaped symbols.

21. A method of wireless communication performed by a network node, comprising:
applying, by the network node, a probabilistic amplitude shaping in discrete Fourier transform spread orthogonal frequency division multiplexing (DFT-s-OFDM) to a plurality of symbols to obtain a plurality of shaped symbols, wherein the probabilistic amplitude shaping is associated with a probability distribution with a steeper-than-Gaussian decay; and
transmitting, by the network node, a signal associated with the plurality of shaped symbols.
